(19) United States
(12) Patent Application Publication
(10) Pub. No.: US 2006/0016629 A1
(43) Pub. Date: Jan. 26, 2006

(54) Regenerative suspension system

(76) Inventor: George R. Huard, Palo Alto, CA (US)

Correspondence Address: George R. Huard, 562 Kendall Ave. #39, Palo Alto, CA, 94306, US

(21) Appl. No.: 11/183,472

(22) Filed: Jul. 18, 2005

Related U.S. Application Data
(60) Provisional application No. 60/590,763, filed on Jul. 23, 2004.

(51) Int. Cl. B60K 1/00

(52) U.S. Cl. 180/65.1

(57) ABSTRACT

At a chassis pivot point (4) the vehicle bouncing wheel linkage arm (5) torquing a torsion rod (6), or rod (6) and journal (6A) in combination, through a one-way over-running clutch (9) to spin a magnet carrying flywheel/armature (10) concentrically about the stator/chassis mount assembly (11) creating the electrical output to recharge the vehicle's battery complement (not shown). Injected rigid foam fill (12) of journal (6A) optional.

### CROSS REFERENCE

This application claims the benefit of provisional patent application Ser. No. 60/590/763, filed 2004, Jul. 23 by the present inventor.

### FEDERAL RESEARCH

Not Applicable

### SEQUENCE LISTING

Not Applicable

### BACKGROUND

This invention relates to the capture of the motions and forces of a vehicie's suspension system to spin generators to recharge the vehicle's battery complement.

### PRIOR ART

Computer search reveals no mechanical linear to rotary recovery of the vehicle's suspension system motions and forces to produce the electrical energy required to recharge the vehicle's batteries. This invention is intended to be an “always-on” regenerative electrical energy source to recharge the vehicle's batteries thereby significantly increasing the vehicles range. This electrical source is supplemental to the existing regenerative braking popular in current all-electric and hybrid vehicle's.

In the absence of a supplemental regenerative source of electrical capacity the practical long range all-electric vehicle will never be attained. There also will not be a long range highway hauler hybrid since its brakes are seldom used, regenerative braking or no! No gain, its internal combustion engine would always be activated. Witness the diesel-electric train!

With the additional electrical capacity of a regenerative suspension system the picture changes dramatically! The much longer range inter-urban all-electric utility vehicle becomes a practical reality! In the hybrid hauler application this additional electrical capacity would dramatically reduce the “engine on” interval! The economies here are manifest, in the all-electric, only the cost of over-night recharging of its batteries! In the hybrid hauler application, reduced “engine on” time and the attendant savings in the cost of fuel!

The environmental consequences are equally as dramatic! In the all-electric vehicle, the truly zero polluting conveyance! In the hybrid hauler application the reduced “engine on” sequence significantly reduces the burning of a fossil fuel! In the aggregate, the global use of zero-polluting inter-urban vehicle's alone could dramatically reduce global warming and the destruction of the ozone layer over time!

This invention relates to the capture of the kinetic activity of the vehicle's suspension system by mechanical means, energizing a torsion rod to spin a flywheel, reciprocating “bounce” motion converted to rotary motion via a one-way running clutch centrally imbedded in the flywheel hub. Ideally, the flywheel is the magnet-carrying rotor of a generator. For this particular application a commercially available clutch featuring built-in overload protection is strongly recommended to ensure its longest lifespan.

This invention, a regenerative energy mechanism could well represent a new era in transportation, an easily incorporated device to satisfy all demands of the successful long range all-electric or hybrid vehicle!

### SUMMARY

In accordance with the present invention, a mechanical regenerative suspension system, the means to significantly extend the range of the electric vehicle whether hybrid or all-electric. The opportunity to vastly reduce the consumption of fossil fuels to eliminate to great extent the creation of hazardous emissions. The vast reduction of global warming and the ozone layer.

### DRAWINGS

FIG. 1 to show the operation of the “Bounce Engine” to mechanically capture the motions and forces of a vehicle's suspension system to spin electrical generators.

FIG. 2 to illustrate the theory of operation, the forgiving relative velocities of its components to minimalize shock loads.

FIG. 3 to illustrate the means to “fit” the extended length “Bounce Engine” within the restricted confines of the vehicle's wheel well.

### REFERENCE NUMERALS

| | | | |
|---|---|---|---|
| 4 | chassis pivot point | 8 | brazement |
| 5 | input linkage | 9 | over-running clutch |
| 6 | torsion rod | 10 | flywheel/armature |
| 6A | journal | 11 | stator/chassis mount |
| 7 | weldment | 12 | injection |

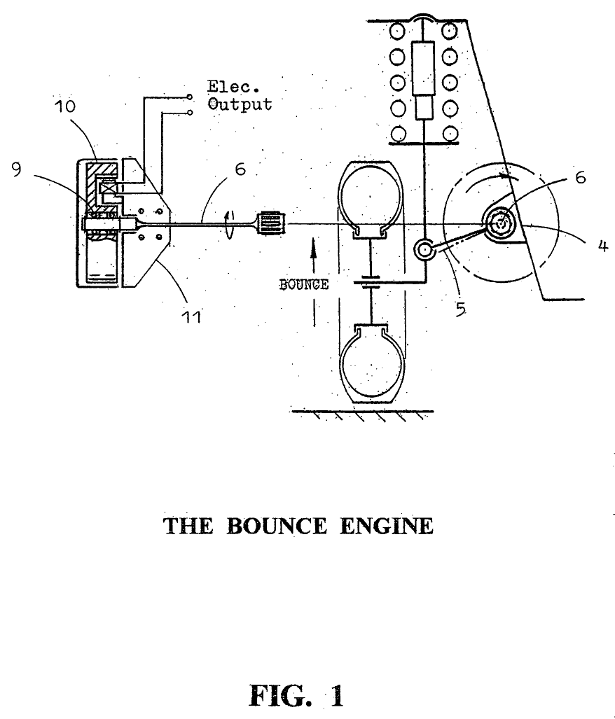

### DETAILED DESCRIPTION—FIGS. 1, 2, and 3

A preferred embodiment of the system of the present invention and mode of operation is illustrated in FIG. 1. (elev. view). At chassis pivot point 4 the bouncing wheel linkage arm 5 drives (twists) a bearing supported torsion rod 6 activating a one-way over-running clutch 9 centrally embedded in the hub of and spinning flywheel 10 that holds integral magnets of an electrical generator/alternator rotor, its output recharging the vehicle's battery complement. Stator/chassis mount 11 supports the generator assembly.

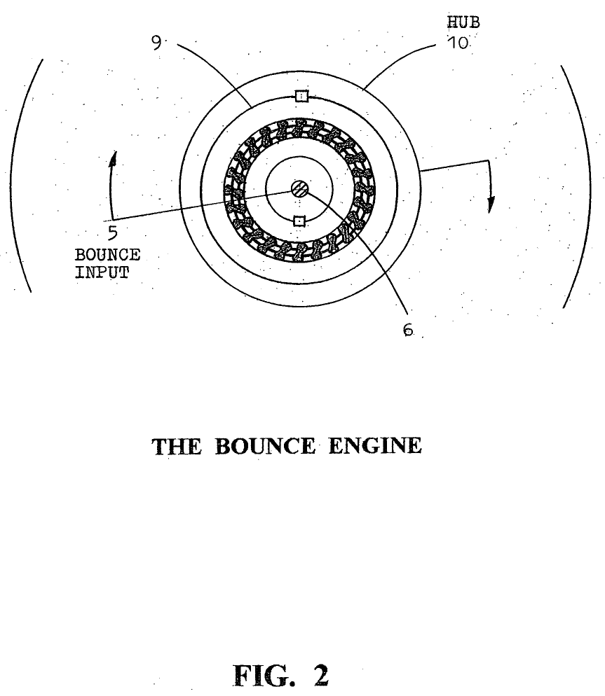

Addressing high velocity shock loads anticipated in this mechanism, see FIG. 2 (axial view). Since the vehicle always begins its trek from a standing start, the initial suspension deflections are low in frequency, amplitude and velocity. As the vehicle accelerates, the over-running clutch 9 sprag elements experience only those forces generated by the difference in the angular velocities of wheel linkage input Vₗ and flywheel V_{f} already in motion! Conversely, even lower shock loads can be realized by the reverse rotation installation of over-running clutch 9 to capture instead the suspension rebound force (stroke) to spin the flywheel generator set! In either scenario, intervening torsion rod 6 remains, in itself, a superb shock absorber! It follows then that the flywheel receives additional impetus only when Vequals or exceeds V_{f}! All of the above suggests the “soft landing” lock-up of the clutch sprag elements in the drive mode.

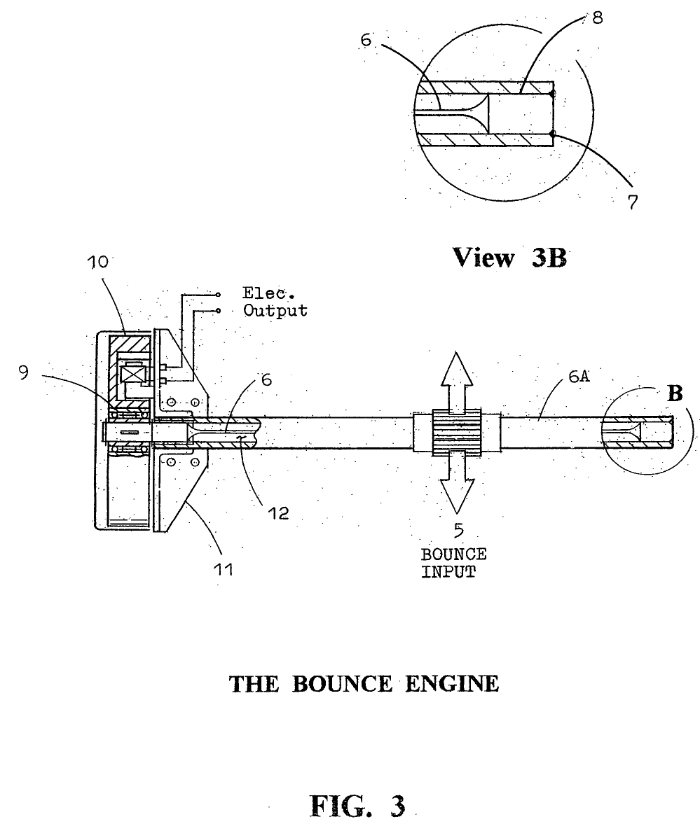

The compact means to achieve sufficient compliant length of torsion rod 6 in the restrictive confines of the vehicle's wheel well is illustrated in FIG. 3. The bounce input 5 simulteously drives both torsion rod 6 and extended rigid tubular journal 6A, both being co-joined by peripheral weldment 7 and brazement 8 at the end of the extention shown in View 3B. Although optional, an injected rigid foam fill 12 is recommended for torsion rod support in the inner journal void area indicated. In either configurations shown in FIGS. 1, 2, and 3, all generator and mount elements remain the same. The commercial clutch chosen should include the over-load protection feature to ensure maximum clutch life expectancy

The design goal then is to achieve the minimally “stiff” torsion rod and lowest flywheel mass yet able to convey all input forces to affect a consistently smooth electrical output.

1. The linear to rotary mechanical conversion of a vehicle's suspension bounce motions and forces to drive counter-rotating generators at front and/or rear wheel positions, creating an excess of electrical capacity to recharge a vehicle's battery complement.

2. Said excess of electrical capacity to significantly increase the vehicle's range whether a hybrid or all-electric vehicle.

3. Said excess of electrical capacity to also provide the energy for heating of the electrolyte in the vehicle's batteries for efficient operation in the cold climate environment.

4. Said excess of electrical capacity to also afford the use of the simple low-cost lead/acid batteries, and fewer in number.

5. Said excess of electrical capacity to provide all vehicle electrical requirements, including air-conditioning.
